(19) United States
(12) Patent Application Publication
(10) Pub. No.: US 2026/0321707 A1
(43) Pub. Date: Oct. 15, 2026

(54) BATTERY MODULE

(71) Applicant: Robert Bosch GmbH, Stuttgart (DE)

(72) Inventors: Roman Marx, Moensheim (DE); Andreas Ruehle, Bietigheim-Bissingen (DE); Denny Schmidt, Winnenden (DE)

(21) Appl. No.: 19/642,757

(22) Filed: Apr. 9, 2026

(30) Foreign Application Priority Data
Apr. 10, 2025 (DE) 10 2025 114 180.0

(51) Int. Cl. H01M 10/04; H01M 10/658; H01M 50/209; H01M 50/224

(52) U.S. Cl. CPC H01M 10/0481; H01M 10/658; H01M 50/209; H01M 50/224

(57) ABSTRACT

A battery module with a plurality of battery cells, which are arranged adjacent to one another in a longitudinal direction of the battery module between two end plates. The end plates are further connected to each other by tensioning elements such that the plurality of battery cells are clamped together. A compensating material is also arranged between a battery cell and a tensioning element. A tensioning element immediately adjacent to an end plate comprises a recess.

### BACKGROUND

The invention relates to a battery module according to the type defined in the disclosure.

It is known from the prior art that a battery module comprises a plurality of individual battery cells, each of which has a positive voltage tap and a negative voltage tap, wherein the respective voltage taps are electrically conductively connected to one another for an electrically conductive serial and/or parallel connection of the plurality of battery cells to one another and can thus be interconnected to form the battery module.

Battery modules, in turn, are connected together to form batteries or battery systems. Installation space in vehicles is often limited, so in addition to variable module sizes, optimal utilization of the available installation space should also be sought.

### SUMMARY

A battery module with the features of the disclosure offers the advantage that a reliable clamping connection can be formed.

In accordance with the invention, a battery module with a plurality of battery cells, in particular lithium-ion battery cells, is provided for this purpose. The battery cells are arranged adjacent to each other in a longitudinal direction of the battery module between two end plates. Furthermore, the end plates are connected to each other by means of tensioning elements such that the plurality of battery cells are clamped together. Furthermore, a compensating material is also arranged between a battery cell and a tensioning element. A tensioning element immediately adjacent to an end plate comprises a recess.

At this point, it should be noted that the recess can be configured to extend completely through the tensioning element, or the recess can be configured only as a depression in the tensioning element. As a result, in the case of a recess formed to extend completely through the element, excess compensating material can be discharged through the recess. Furthermore, in the case of a configuration as a depression, excess compensating material can be collected or trapped within the recess.

At this point, it should be noted that the compensating material serves to compensate tolerances between the tensioning element and the battery cells, or is configured as such. Particularly in the case of comparatively small tolerances, the compensating material is pressed in all spatial directions during the manufacturing process. This makes it possible to reliably compensate all tolerances and fill free areas. This makes it possible to reliably compensate tolerances.

Furthermore, the compensating material can in particular be configured for thermal coupling, mechanical fastening, and/or electrical isolation.

With one embodiment according to the invention, tolerance compensation can be achieved by means of the compensating material.

A minimum layer thickness of the compensating material is to be matched to a maximum permissible particle size of residual contamination such that electrical isolation between the battery cells and the tensioning element is always ensured. Furthermore, it is also conceivable that the tensioning element comprises a coating for electrical isolation, such as a catalytic dip coating or an insulation film.

The invention offers the advantage that, on the one hand, excess compensating material can be discharged through the recess and that, on the other hand, the connection point between an end plate and a tensioning element can be protected from being wetted with the compensating material. Wetting the connection point with compensating material would result in an additional separating layer, through which a reliable connection could not be ensured.

With one embodiment of the battery module according to the invention, these disadvantages can be overcome by a recess.

In an adjacent arrangement of the battery cells in a longitudinal direction of the battery module, the battery cells are arranged adjacent to one another by way of their respective largest lateral surfaces, which are in particular each arranged perpendicular to the upper lateral surface and to the lower lateral surface. It should be noted at this point that the longitudinal direction of the battery module in this case is accordingly arranged perpendicular to the largest side surfaces of the battery cells.

It is advantageous if each of the plurality of battery cells is designed as a prismatic battery cell. At this point, it should be noted that prismatically formed battery cells each comprise a battery cell housing with a total of six lateral surfaces, which are arranged in pairs opposing each other and essentially parallel to each other. In addition, lateral surfaces arranged adjacent one another are arranged perpendicular to one another. The electrochemical components of the respective battery cell are accommodated within the interior of the battery cell housing. Typically, two voltage taps, in particular a positive voltage tap and a negative voltage tap, are arranged on an upper lateral surface, which is referred to as the cover surface. The lower lateral surface opposite the upper lateral surface is referred to as the bottom surface.

It is expedient if two adjacent battery cells are arranged so as to be thermally isolating or thermally insulating relative to one another, such that heat conduction between the two adjacent battery cells is prevented or reduced, wherein in particular a thermal isolation element or thermal insulation element is arranged between the two adjacent battery cells.

Preferably, the two end plates and/or the tensioning elements are each formed from a metallic material, such as a steel material, which has a comparatively high tensile strength, a comparatively high elongation at break, and a comparatively high modulus of elasticity, so that mechanical forces can be transferred.

A design made of an aluminum alloy is also conceivable, for example.

In particular, a connection between an end plate and a tensioning element is designed to be form-fitting and/or materially bonded, in particular by welding. In particular for a compact design of the battery module, it is advantageous to design the connection as a welded joint. This can reliably transmit even high forces.

According to a preferred aspect of the invention, the compensating material is a thermal compensating material, which is in particular configured as a thermally conductive adhesive or as a gap filler or as a gap pad. Thus, in particular, a thermally conductive adhesive is arranged between a side surface of a battery cell and a tensioning element. For example, such a thermally conductive adhesive may also comprise thermally conductive additives. During manufacture, it is conceivable to apply the adhesive to both the battery cells and the tensioning element.

It is also particularly advantageous that the battery cells are additionally bonded in a housing of the battery module with such a thermally conductive adhesive, so that advantageously two different adhesives do not need to be used.

A longitudinal direction of the recess is particularly expediently arranged perpendicularly to the longitudinal direction of the battery module. In particular, the recess is configured as a groove, which is, in particular, also arranged perpendicularly to a direction of flow of the adhesive.

It is also advantageous if a recess is formed from a plurality of recess elements. In this case, the recess can be segmented as desired; in particular, a configuration with a sequence of a plurality of circular cutouts is advantageous.

At this point, it is noted that the recess is to be dimensioned, such that sufficient mechanical stability of the connection is ensured.

### BRIEF DESCRIPTION OF THE DRAWINGS

Exemplary embodiments of the invention are shown in the drawings and explained in more detail in the following description.

Shown are:

FIG. 1 a perspective exploded view of an embodiment of a battery module according to the invention,

FIG. 2 a perspective view of the embodiment of the battery module according to the invention, and

FIG. 3 a cutout of an embodiment of a battery module according to the invention.

### DETAILED DESCRIPTION

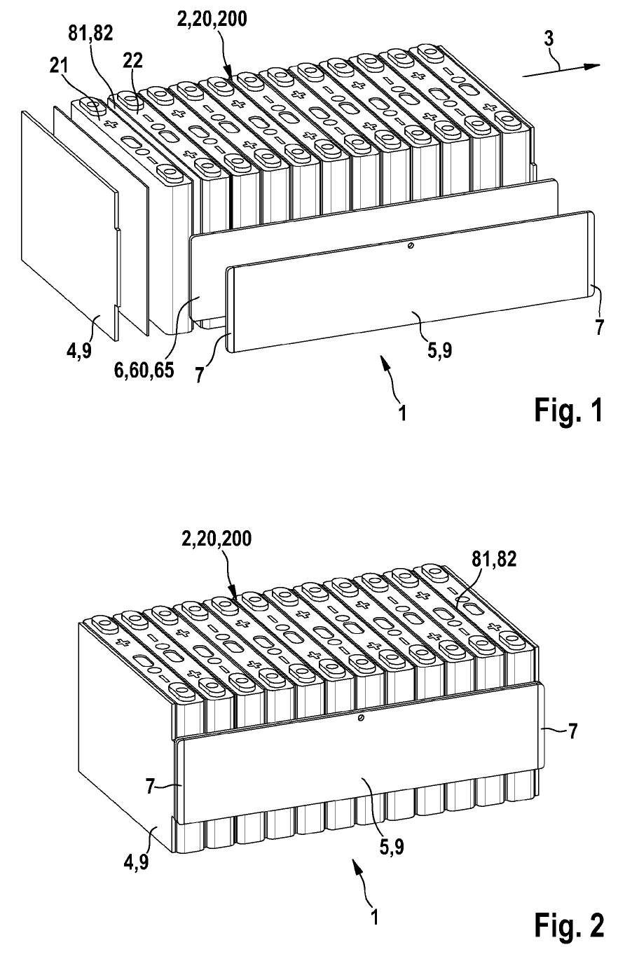

FIG. 1 shows a perspective exploded view of an embodiment of a battery module 1 according to the invention. FIG. 2 shows this embodiment in a perspective view.

The battery module 1 comprises a plurality of battery cells 2, in particular lithium-ion battery cells 20, each of which is a prismatic battery cell 200 according to FIG. 1.

The plurality of battery cells 2 is arranged adjacent to one another in a longitudinal direction 3 of the battery module 1 between two end plates 4.

A thermal isolation element 81 or thermal insulating element 82 is further arranged between two battery cells 21, 22 arranged adjacent to each other, such that the two battery cells 21, 22 arranged adjacent to each other are thermally isolated or thermally insulated from each other, and heat conduction between the two battery cells 21, 22 arranged adjacent to each other is reduced or prevented.

Furthermore, the end plates 4 are connected to each other by means of tensioning elements 5, such that the plurality of battery cells 2 are clamped together. A compensating material 6 is further arranged between a battery cell 2 and a tensioning element 4. The compensating material 6 is a thermal compensating material 60, which is furthermore in particular a thermally conductive adhesive 65. Furthermore, the thermal compensating material may be configured as a gap filler or as a gap pad.

In particular, the end plates 4 and the tensioning elements 5 are each connected to one another in a form-fitting and/or materially bonded manner. FIG. 2 shows an embodiment, in which the connection is, for example, welded.

The two end plates 4 and the tensioning elements 5 are each made of a metallic material 40.

Furthermore, the tensioning element 5 immediately adjacent to an end plate 4 comprises a recess 7.

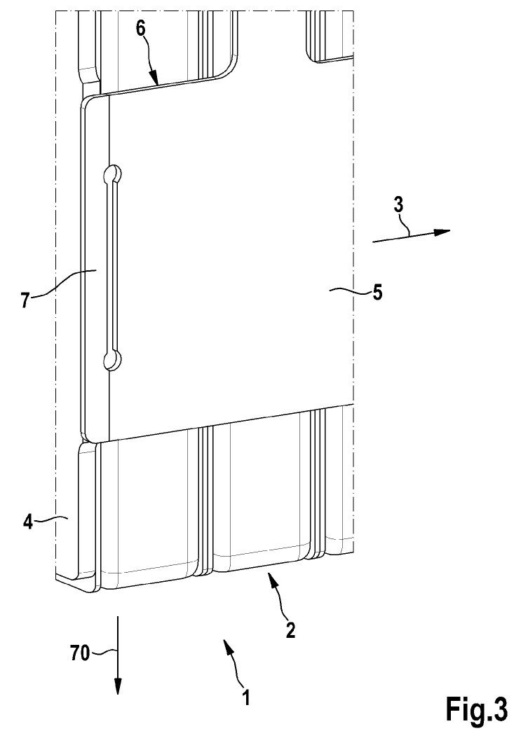

FIG. 3 shows a cutout of an embodiment of a battery module 1 according to the invention.

Here, battery cells 2 as well as a tensioning element 5 and an end plate 4 can initially be seen. The compensating material 6 is arranged between the battery cells 2 and the tensioning element 4.

In FIG. 3, the recess 7 can also be seen in particular. A longitudinal direction 70 of the recess 7 is arranged perpendicularly to the longitudinal direction of the battery module 1. Preferably, the recess 7 may be formed from a plurality of recess elements, which is not shown in FIG. 3.

1. A battery module with a plurality of battery cells (2), which are arranged adjacent to one another in a longitudinal direction (3) of the battery module (1) between two end plates (4), wherein
the end plates (4) are further connected to each other by tensioning elements (5) such that the plurality of battery cells (2) are clamped together, wherein
a compensating material (6) is also arranged between a battery cell (2) and a tensioning element (5),
wherein
a tensioning element (5) immediately adjacent to an end plate (4) comprises a recess (7).

2. The battery module according to claim 1,
wherein
each of the plurality of battery cells (2) is formed as a prismatic battery cell (200).

3. The battery module according to claim 1,
wherein
two adjacent battery cells (21, 22) are arranged so as to be thermally isolating or thermally insulating relative to one another, such that heat conduction between the two adjacent battery cells (21, 22) is prevented or reduced, wherein, a thermal isolation element (81) or thermal insulation element (82) is arranged between the two adjacent battery cells (21, 22).

4. The battery module according to claim 1,
wherein
the two end plates (4) and/or the tensioning elements (5) are each made of a metallic material (9).

5. The battery module according to claim 1,
wherein
a connection between an end plate (4) and a tensioning element (5) is form-fitting and/or materially bonded, in particular welded.

6. The battery module according to claim 1,
wherein
the compensating material (6) is a thermal compensating material (60), which is formed as a thermally conductive adhesive (65) or as a gap filler or as a gap pad.

7. The battery module according to claim 1,
wherein
a longitudinal direction (70) of the recess (7) is arranged perpendicularly to the longitudinal direction (3) of the battery module (1).

8. The battery module according to claim 1,
wherein
the recess (7) is formed from a plurality of recess segments.

9. The battery module according to claim 1, wherein the plurality of battery cells (2) are lithium-ion battery cells (20).

10. The battery module according to claim 5, wherein the connection between the end plate (4) and the tensioning element (5) is welded.
